(19) United States
(12) Patent Application Publication
(10) Pub. No.: US 2015/0166308 A1
(43) Pub. Date: Jun. 18, 2015

(54) METHOD FOR INSTALLING AND REMOVING CONCRETE BLOCKS

(71) Applicant: Manitowoc Crane Group France SAS, Dardilly (FR)

(72) Inventor: Guillaume REYMOND, Montilly (FR)

(73) Assignee: Manitowoc Crane Group France SAS, Dardilly (FR)

(21) Appl. No.: 14/105,671

(22) Filed: Dec. 13, 2013

(51) Int. Cl. B66C 1/66

(52) U.S. Cl. CPC B66C 1/666

(57) ABSTRACT

A method of installing and removing concrete blocks involves using handling device that is equipped with means for attaching and suspending a concrete block and which itself comprises a protective barrier placed temporarily on the concrete block to safeguard the operations of detaching or attaching this block. The barrier advantageously has safeguarded lateral access of the safety bow type that comes into register or alignment with rungs with which the concrete blocks are equipped. The method keeps an operator safe while installing and removing stackable concrete blocks, particularly an operation in which the concrete blocks are stacked on a base chassis of a tower crane.

### BACKGROUND

The subject-matter of the present invention is, in general, a method for installing and removing stackable concrete blocks, this method being more particularly applicable to concrete ballast blocks that can be stacked on a base chassis of a crane in order to ballast the crane. Another subject of the invention is a handling device intended for implementing this method that handles the concrete blocks and affords protection.

In a way that is generally known, a crane, and particularly a tower crane, is weighted down by placing and stacking varying numbers of concrete ballast blocks on the base chassis of such a crane.

A handling device suitable for handling stackable concrete ballast blocks that allows the ballast blocks to be brought in succession one on top of the others is already known, for example, from French Patent FR 2 854 393 B1. When using such handling device, an operator must, after placing each concrete block, climb up onto the top of the stack already produced, which may be at a height of several metres, in order to detach the slings of the handling device. During these operations, the operator does not currently enjoy any measure of safety against the risks of falling, unless he uses a safety harness, which appears challenging.

To make it easier for the operator to gain access to the top of a stack of concrete ballast blocks when installing or removing crane ballast, it has already been proposed for each concrete ballast block to be equipped with at least one stirrup or rung, situated on its edge. Thus, the superposed corresponding rungs of the stacked ballast blocks form a kind of ladder making it easier for the operator to gain access to the top of the stack of ballast blocks, as seen in European Patent EP 1 205 422 B1.

This arrangement may well make the operations of installing crane ballast blocks easier, but it affords no measure of safety to an operator who has arrived at the top of the stack of ballast blocks.

Various protective barrier systems for operators working at a height or in other hazardous situations are known from elsewhere.

For example, Japanese Patent JP 11-152944 and U.S. Pat. No. 7,213,715 B2 disclose protective barriers designed to avoid accidental falls through a “manhole”.

Other documents, such as French Patent FR 2 894 232 B1 or European Patent Application EP 2 253 580 A1, disclose platforms for working at height with guard rails and lateral access. These platforms have a solid floor which prevents certain types of intervention. In addition, their lateral access usually consists of a simple gate, which does not afford safety.

These known protective barrier systems are not suitable for the operations of placing and stacking concrete ballast blocks, particularly for ballasting a crane.

### BRIEF SUMMARY

The present invention seeks to overcome the aforementioned disadvantages and its object is therefore to provide a method and a handling device which are suitable for affording the operator optimum safety when installing and removing stackable concrete blocks, particularly during operations of ballasting a crane using such blocks.

To this end, the method of the invention consists essentially, for installing and removing stackable concrete blocks, particularly concrete blocks provided with at least one rung on their edge. A handling device or equipment for use with these concrete blocks is equipped with means for attaching and suspending a concrete block. The handling device itself comprises a protective barrier closed up on itself and provides lateral access. The protective barrier is placed temporarily on a concrete block in order to safeguard the operations of detaching or attaching the concrete block to the handling device.

In one preferred embodiment of the method of the invention, the handling device comprises a protective barrier. The lateral access to the protective barrier includes a safety bow that comes into register or alignment with rungs of the stacked concrete blocks when the protective barrier is placed on a concrete block situated at the top of the stacked concrete blocks.

Thus, the idea underlying of embodiments of the invention is to use a special-purpose handling device or equipment which is used both as a lifting beam for picking up and handling the concrete ballast blocks and as a protective barrier for the operator stationed at the top of the stack of concrete blocks during operations of detaching or attaching these blocks. In addition, in so far as the protective barrier is provided with a safeguarded lateral access of the safety bow type that aligns or registers with a ladder made up of the vertical alignment of the rungs of the stacked concrete blocks, the method thus affords greater safety at the moment the operator gains access via this ladder to the top of the stack of concrete blocks.

The special-purpose handling device used in the method of the invention is itself handled using an auxiliary lifting appliance such as a truck-mounted lifting apparatus, which may in particular be the truck used to bring the ballast blocks onto the site concerned or another mobile crane.

The handling device intended for implementing the method, defined hereinabove, comprises a protective barrier closed up on itself and provided with a lateral access but no floor. The protective barrier further comprises means for suspending it from a hook of a lifting appliance, notably by slings, and means for attaching and suspending under said the protective barrier a concrete block that is to be installed or removed.

In an embodiment of this handling device, the lateral access of the protective barrier includes a safety bow extending at least to a height of the protective barrier in a region thereof. By climbing up the ladder formed by the superposed rungs of the stacked concrete ballast blocks, the operator comes up inside the safety bow and from there gains direct access to the space delimited by the protective barrier that surrounds him on all sides. The absence of any floor under the protective barrier may give the operator direct access to the attachment and suspension means, notably for detaching a concrete block which has just been placed at the top of the stack.

Overall, embodiments of the invention thus provide a solution which, while remaining constructionally simple and economical, affords optimum safety during operations of installing concrete ballast blocks and, naturally too, during the reverse operations of removing these concrete ballast blocks, by virtue of a protective barrier that forms a handrail, preferably supplemented by a safety bow. In so doing, the operator finding himself relieved of the need for equipment of the harness type which is difficult to work with for this kind of operation. In addition, the fact that there is no floor at the base of the protective barrier prevents the handling device from being misused as a gondola for transporting or lifting people, which current regulations prohibit.

In any event, the invention will be better understood from the description which follows, with reference to the attached schematic drawing which, by way of example, depicts an embodiment of this handling device and illustrates the use thereof in accordance with the method of the invention.

### BRIEF DESCRIPTION OF THE DRAWINGS

FIG. 1 is a perspective view of a handling device on its own;

FIG. 2 shows the handling device of FIG. 1 suspended from a crane (not depicted);

FIG. 3 illustrates the placing of the handling device of FIG. 1 on a ballast block;

FIG. 4 illustrates the attaching of the ballast block to the handling device of FIG. 1;

FIG. 5 illustrates the picking up and lifting of the ballast block using the handling device;

FIG. 6 illustrates the placing of the ballast block at the top of a stack of such blocks;

FIG. 7 illustrates the placing of the handling device of FIG. 1 itself on the ballast block that has just been placed;

FIG. 8 illustrates an operator accessing the placed handling device;

FIG. 9 finally illustrates the detaching of the ballast block that has just been placed.

### DETAILED DESCRIPTION

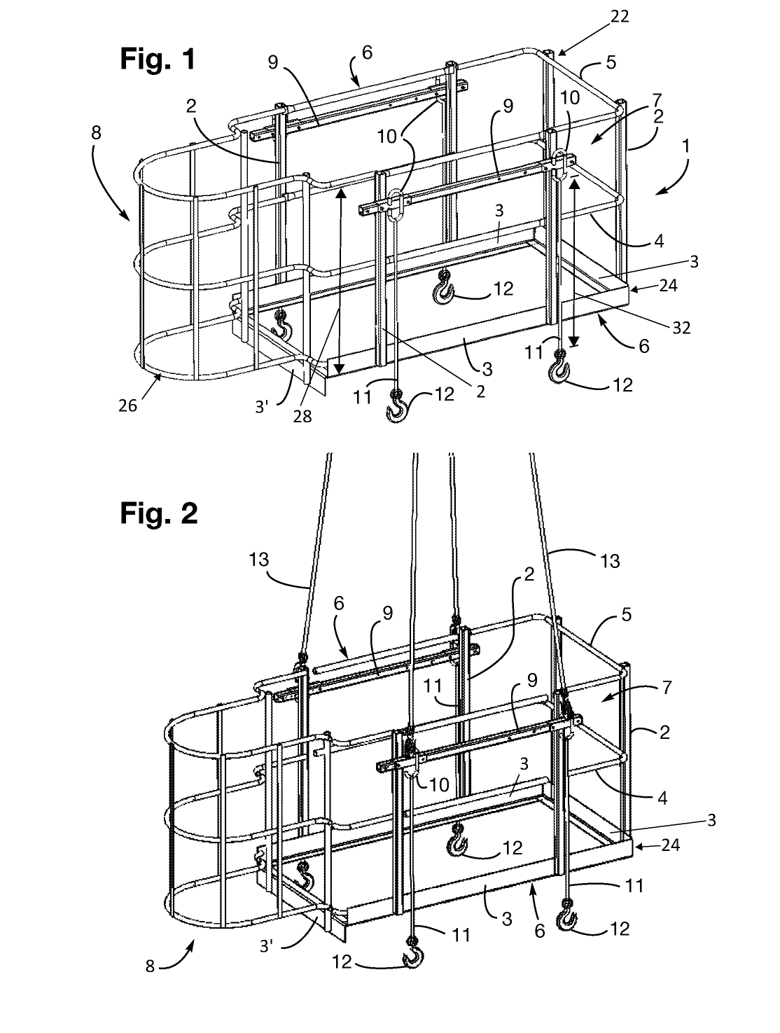

With reference to FIG. 1, the handling device or handling equipment denoted overall by the reference 1 takes the form of a protective barrier 22 closed up on itself and produced in the manner of a handrail. Thus, the protective barrier 22 comprises at least one upright 2—and in some embodiments a plurality of uprights 2—which connects at least one lower profile section 3—and in some embodiments a plurality of lower profile sections 3—to at least one intermediate rail 4 and to at least one top rail 5. Optionally, another lower profile section 3′ is situated on the same side as a safety bow 8. The another lower profile section 3′ is advantageously bent downwards. There is no floor at the base of the protective barrier 22 in the region of the lower profile sections 3 and the another lower profile section 3′ which form a simple rectangular surround 24. In other words, the protective barrier 22 remains completely open at its base.

Viewed from above, the handling device 1 has a rectangular overall shape with at least one and, in some embodiments, at least one longitudinal side 6—an in some embodiments a plurality of two or more longitudinal sides 6—connected by at least one transverse side 7. The transverse side 7 in some embodiments, including the one pictured, is straight. On the opposite side to this straight transverse side 7, the handling device 1 comprises a lateral access 26, including a safety bow 8 which extends at least to a height 28 of the protective barrier 22.

On the two longitudinal sides 6, the uprights 2 of the protective barrier 22 are equipped with means for attaching and suspending a concrete block 14. These means include means for attaching and suspending the concrete block 14 that is to be installed or removed from under the protective barrier 22. These means include, for example, a respective horizontal crossmember 9 that connect the uprights 2; rings 10; cables 11; and hooks 12. On each side, two rings 10 are passed around or coupled to the crossmember 9. The rings 10, in turn, are connected by respective cables 11 to two hooks 12. A length 32 of the cables 11 is such that in the free state the hooks 12 are located a little lower down than the profile sections 3 of the protective barrier 22. In other words, the hooks 12 hang below the lower profile section 3 when the hooks 12 are not connected to anything. Overall then, the handling device 1 has four hooks 12 arranged at the four corners of a rectangle, in one and the same horizontal plane.

As illustrated in FIG. 2, the handling device 1 described hereinabove includes means for attaching and suspending the protective barrier 22 from a hook of a lifting appliance, such as a mobile crane. For example, the protective barrier 22 can be suspended from a mobile crane (not depicted) using means for attaching and suspending the protective barrier 22 that include four slings 13 connected to a hook of the mobile crane. The means for attaching and suspending the protective barrier 22 further include the rings 10 that are passed around or coupled to the crossmembers 9. The slings 13 are themselves, in turn, attached to the rings 10.

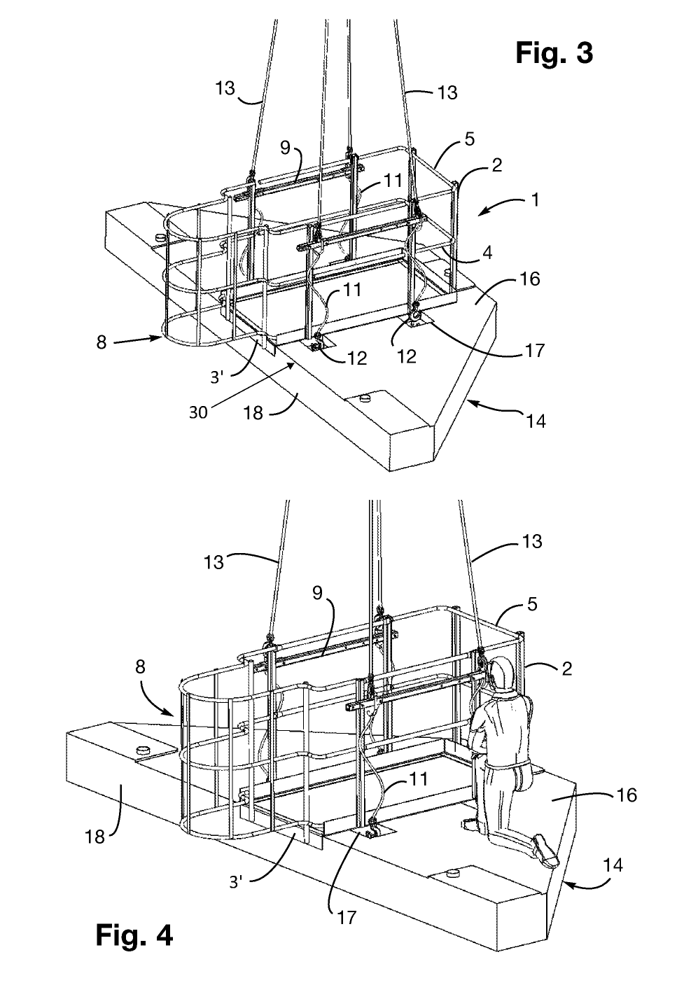

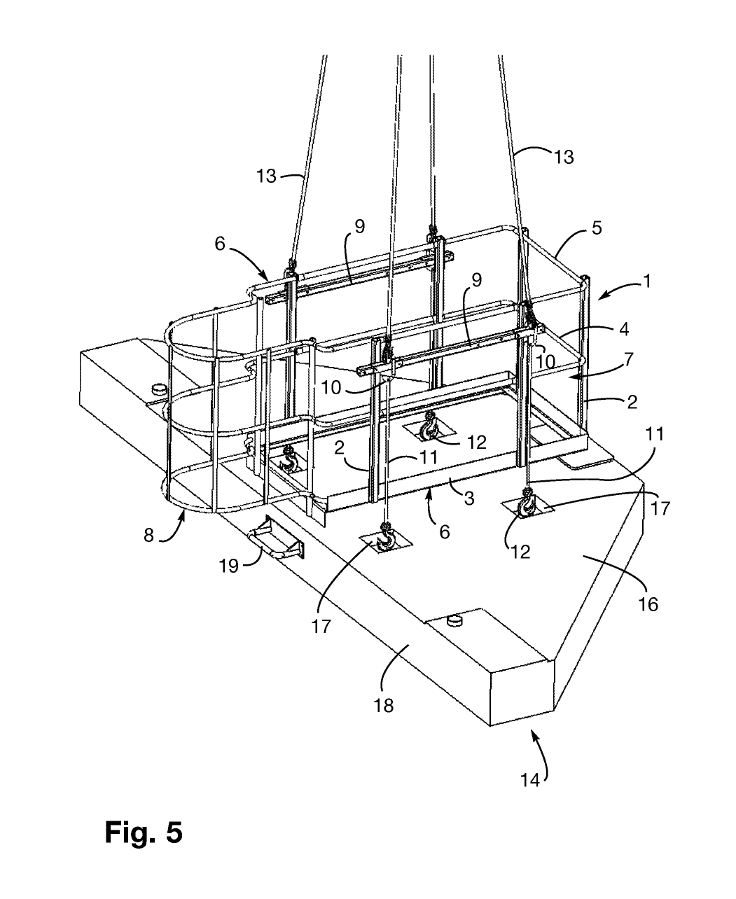

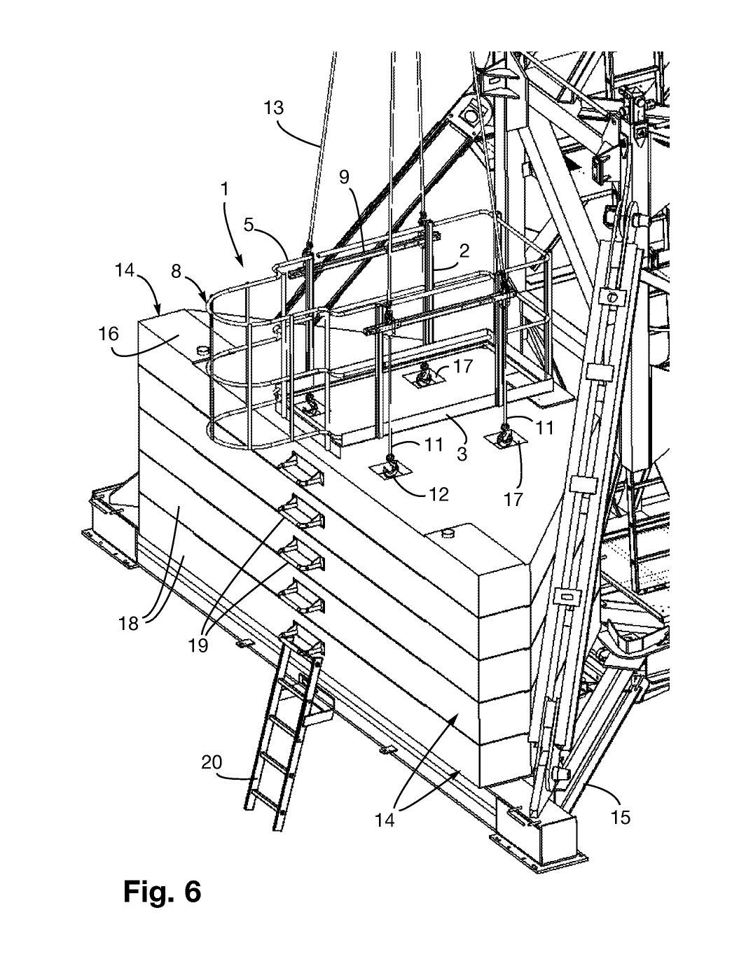

When the handling device 1 is in use, this use being illustrated in FIG. 3 and the following figures, the hooks 12 are designed for attaching and suspending a concrete ballast block 14 intended for ballasting a tower crane. In a known way, such ballast blocks 14 are stacked, in varying numbers, on the base chassis 15 (seen in FIGS. 6-9) of the tower crane. Each ballast block 14 here comprises, on its top face 16, four cavities 17 each one fitted with a lifting ring. Each ballast block 14 is also provided, on its edge 18, with a rung 19 (seen in FIGS. 5-9). Thus, the vertically aligned rungs 19 belonging to a number of superposed ballast blocks 14 form a ladder making it easier to gain access to the top of the stack of these ballast blocks 14. In so far as the rung 19 of the bottom ballast block 14 is already situated a certain height above the ground, a short ladder 20 (seen in FIGS. 6-9) may be installed at the base chassis 15 in order to make access to this first rung 19 easier.

The use of the handling device 1 itself will now be described, considering the operation of installing an additional ballast block 14 at the top of a stack already made up of several similar ballast blocks 14.

With the additional ballast block 14 ready and waiting, in a horizontal position, the handling device 1 handled by the mobile crane through the slings 13 is first of all brought towards this block and placed on the top face 16 thereof, as shown by FIG. 3. It will be noted that another lower profile section 3′ situated on the same side as the safety bow 8 is advantageously bent downwards so as to form an end stop 30 which, in collaboration with the edge 18 of the ballast block 14, serves to position the handling device 1. The four cables 11 and their respective hooks 12 then come into register with the four cavities 17 of the ballast block 14.

As illustrated in FIG. 4, an operator can then attach the four hooks 12 to the corresponding lifting rings of the cavities 17, the length of the cables 11 giving them enough “slack” that this attachment operation can be performed. The ballast block 14 is thus attached under the handling device 1.

Next, the mobile crane is used to lift the device 1 via the slings 13 and the handling device 1 in turn lifts the ballast block 14 that has just been attached via the cables 11. The cables 11 become tensioned, and the ballast block 14 finds itself suspended beneath the handling device 1 as shown by FIG. 5.

The handling device 1, carrying with it the ballast block 14, is moved into position by means of the mobile crane and brought towards the top of the stack already formed of several identical ballast blocks 14, as shown by FIG. 6. Thus an additional ballast block 14 is placed at the top of the stack while the handling device 1 itself remains suspended “in mid-air”.

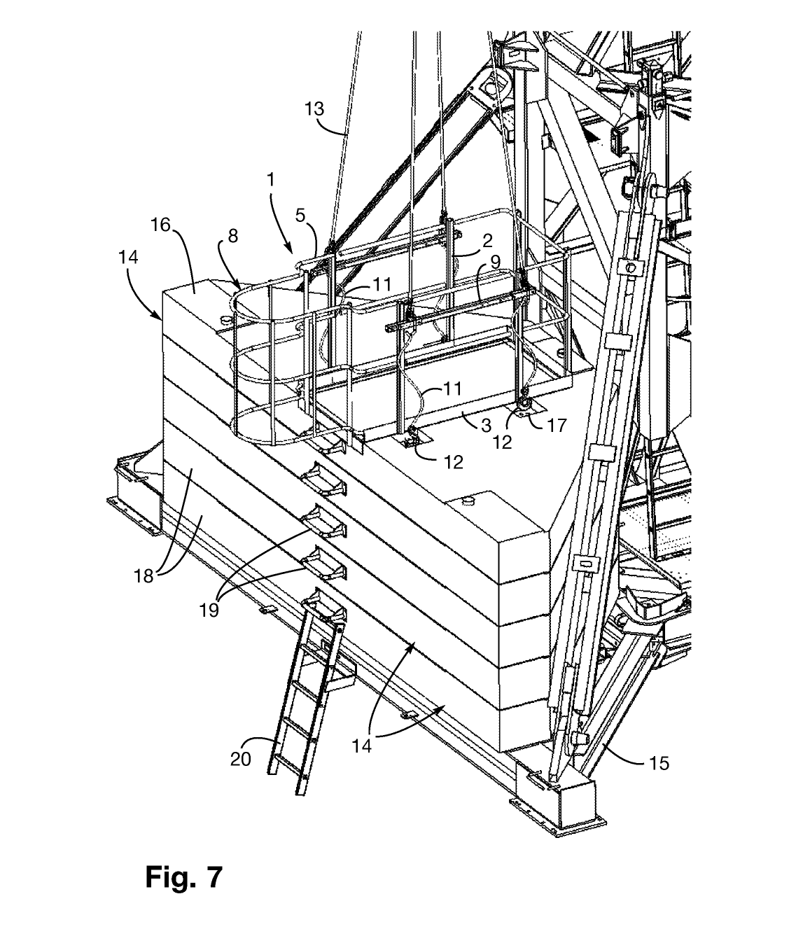

As the handling device 1 continues to be lowered, this handling device 1 is itself placed on the upper top face 16 of the last ballast block 14 that has just been placed, as shown by FIG. 7. The safety bow 8 of the handling device 1 then comes into register or aligns with the ladder made up of the vertical alignment of rungs 19 belonging to the stacked ballast blocks 14.

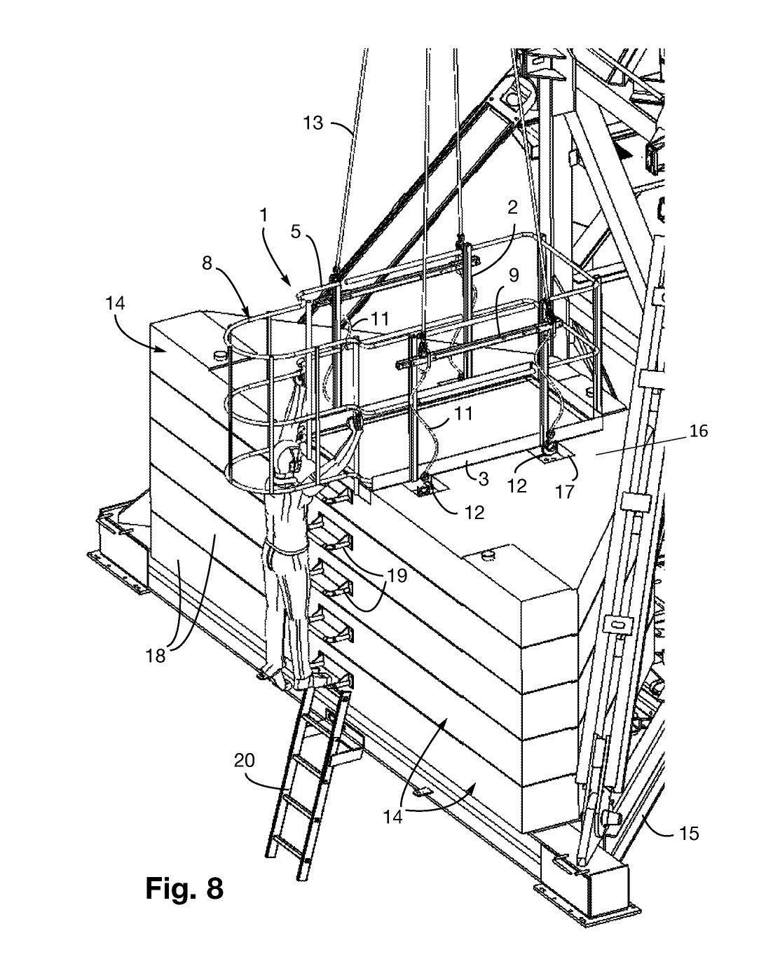

As FIG. 8 illustrates, the operator can then, using this ladder, gain access to the top of the stack of ballast blocks 14 and, more specifically, to the space situated inside the protective barrier 22 formed by the handling device 1. On arriving at the top of the ladder, the operator is kept safe by the safety bow 8.

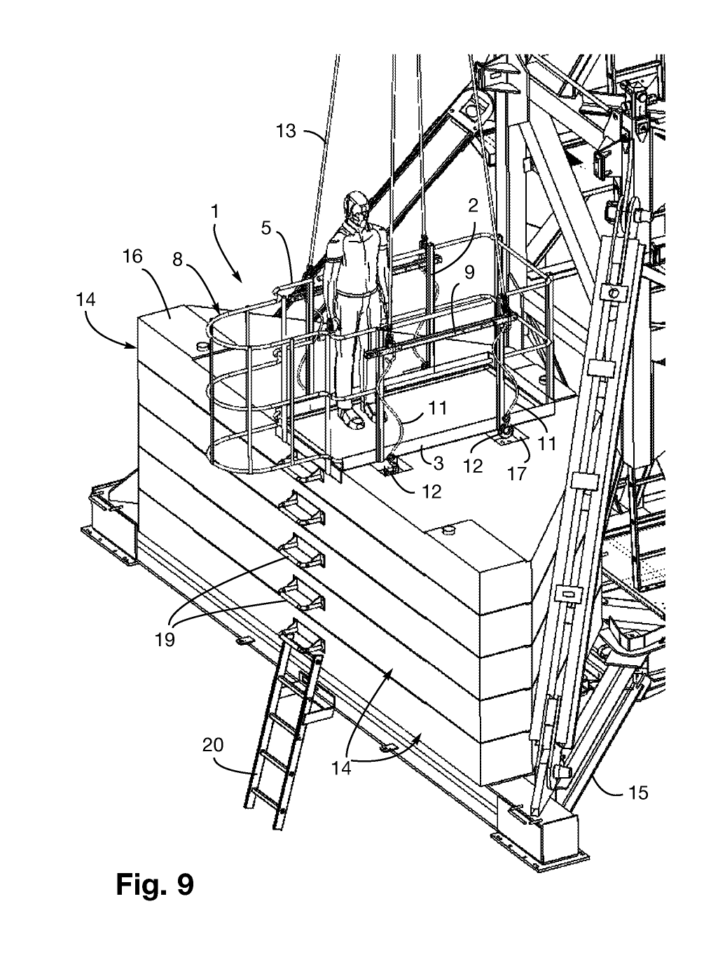

By remaining inside the space delimited by the protective barrier 22, as FIG. 9 finally shows, the operator will be able to detach the last ballast block 14 placed atop the stack of ballast blocks 14 by releasing the hooks 12 from the cavities 17.

Once the detachment operation has been performed, the operator leaves the top of the stack of ballast blocks 14 by coming back down the ladder formed by the aligned rungs 19 of these ballast blocks 14. The freed handling device 1 can then be lifted up and taken away using the mobile crane so that it can be brought towards the next ballast block 14 that is to be placed, the same process being repeated as many times as necessary while keeping the handling device 1 suspended from the mobile crane.

As will be appreciated, the same handling device 1 with protective barrier could also be used for removing the ballast blocks 14; it then protects the operator while the latter is attaching a ballast block 14 that is to be removed from the top of the stack.

The fact that the handling device 1 is open at its bottom and therefore does not constitute a platform or a gondola prevents this handling device 1 from being hijacked or misused for any other purpose, such as a means for transporting or lifting people.

As goes without saying, the invention is not restricted to the one single form of embodiment of this handling device that has been described hereinabove by way of example; on the contrary, it encompasses all alternative forms of embodiment and alternative applications that follow the same principle. Thus, in particular, structural modifications or modifications to the shape of the protective barrier or adaptation of the handling device to suit concrete blocks of a different shape or for a different purpose would not constitute departures from the scope of the invention.

1. A method for installing and removing stackable concrete blocks, particularly concrete blocks provided with at least one rung on an edge of each of said concrete blocks, and more particularly concrete blocks that can be stacked on a base chassis of a crane in order to ballast said crane, the method comprising using a handling device which is equipped with means for attaching and suspending a concrete block, wherein said handling device comprises a protective barrier closed up on itself and provided with a lateral access, said protective barrier being placed temporarily on said concrete block in order to safeguard the operations of detaching or attaching said concrete block from or to said handling device.

2. The method according to claim 1, wherein said lateral access includes a safety bow that aligns with said at least one rung of said concrete block when said protective barrier is placed on said concrete block situated at a top of a stack of concrete blocks.

3. A handling device for installing and removing concrete blocks that can be stacked on a base chassis of a crane in order to ballast said crane, comprising a handling device which is equipped with means for attaching and suspending a concrete block that includes at least one rung on an edge of said concrete block, wherein said handling device comprises a protective barrier closed up on itself and provided with a lateral access, said protective barrier being placed temporarily on said concrete block in order to safeguard the operations of detaching or attaching said concrete block from or to said handling device.

4. The handling device of claim 3, wherein said protective barrier further comprises at least one upright, at least one lower profile section, at least one intermediate rail, at least one top rail, at least one longitudinal side, and at least one transverse side.

5. The handling device of claim 3, wherein said protective barrier lacks a floor.

6. The handling device of claim 4, wherein said means for attaching and suspending said concrete block further comprises means for attaching and suspending said protective barrier from a hook of a lifting appliance by at least one sling and means for attaching and suspending said concrete block that is to be installed or removed from under said protective barrier.

7. The handling device according to claim 4, wherein said protective barrier has a height and wherein said lateral access includes a safety bow that extends to at least said height of said protective barrier.

8. The handling device according to claim 7, wherein said handling device has a rectangular overall shape with two longitudinal sides connected by said at least one transverse side, and wherein said lateral access is situated on a side opposite to said at least one transverse side.

9. The handling device according to claim 6, wherein said protective barrier further comprises a plurality of longitudinal sides and a plurality of uprights, and wherein said plurality of longitudinal sides and said plurality of uprights are connected by a respective horizontal crossmember, two rings passed around each horizontal crossmember, each of said rings being connected by a respective cable to a hook provided for attaching and suspending a concrete block, and each of said rings also being connected to a respective sling for suspending from said hook of said lifting appliance.

10. The handling device according to claim 8, wherein said at least one lower profile section comprises a plurality of lower profile sections and another lower profile section, wherein said plurality of lower profile sections and said another lower profile section form a rectangular surround, and wherein said another lower profile section is situated on said side of said safety bow and said another lower profile section being bent downwards to form an end stop which is used for positioning said handling device in collaboration with said edge of said concrete block.

11. The handling device according to claim 9, wherein said cables have a length such that in a free state each of said hooks are located a little lower down than said plurality of lower profile sections of said protective barrier.

12. A handling device for installing and removing concrete blocks that can be stacked on a base chassis of a crane in order to ballast said crane, said concrete block including at least one rung on an edge of said concrete block, and said handling device capable of being attached to and suspended from a hook of a lifting appliance by at least one sling, said handling device comprising:
a protective barrier that includes:
at least one upright, at least one lower profile section, at least one intermediate rail, at least one top rail, at least one longitudinal side, and at least one transverse side that in combination close said protective barrier upon itself; and,
a lateral access that aligns with said at least one rung of said concrete block when said handling device is positioned atop said concrete block.

13. The handling device according to claim 12, wherein said protective barrier lacks a floor.

14. The handling device of claim 12, wherein said protective barrier has a height and wherein said lateral access includes a safety bow that extends to at least said height of said protective barrier.

15. The handling device according to claim 12, wherein said handling device has a rectangular overall shape with a plurality of longitudinal sides connected by said at least one transverse side, and wherein said lateral access is situated on a side opposite to said at least one transverse side.

16. The handling device of claim 15, wherein said protective barrier further comprises:
a plurality of uprights;
a horizontal crossmember that connects one of said plurality of longitudinal sides to a pair of said plurality of uprights;
another horizontal crossmember that connects another of the plurality of longitudinal sides to another pair of said plurality of uprights.

17. The handling device of claim 16, wherein said protective barrier further comprises two rings passed around said horizontal crossmember and another two rings passed around said another horizontal crossmember, each of said rings being connected by a cable to a hook provided for attaching and suspending said concrete block, and each of said rings provided for attaching to a sling connected to said hook of said lifting appliance.

18. The handling device of claim 14, wherein said at least one lower profile section comprises a plurality of lower profile sections, wherein said plurality of lower profile sections form a rectangular surround.

19. The handling device of claim 18, wherein said plurality of lower profile sections comprises another lower profile section, wherein said another lower profile section is situated on said side of said safety bow and said another lower profile section being bent downwards to form an end stop which is used for positioning said handling device in collaboration with said edge of said concrete block.

20. The handling device according to claim 17, wherein said cables have a length such that said hooks hang below said at least one lower profile section when said hooks are not connected to anything.
